(19) United States
(12) Patent Application Publication
(10) Pub. No.: US 2010/0299165 A1
(43) Pub. Date: Nov. 25, 2010

(54) VALUE NETWORK PERFORMANCE COMPARISON ANALYSIS

(75) Inventors: Mao Chen, El Cerrito, CA (US); Anca-Andreea Ivan, San Jose, CA (US); Jakka Sairamesh, Menlo Park, CA (US)

Correspondence Address: CAREY, RODRIGUEZ, GREENBERG & PAUL, LLP, 950 PENINSULA CORPORATE CIRCLE, SUITE 2022, BOCA RATON, FL, 33487, US

(73) Assignee: International Business Machines Corporation, Armonk, NY (US)

(21) Appl. No.: 12/468,118

(22) Filed: May 19, 2009

(51) Int. Cl. G06Q 10/00

(52) U.S. Cl. 705/7

(57) ABSTRACT

Embodiments of the present invention address deficiencies of the art in respect to modeling value networks and provide a method, system and computer program product for a comparative analysis different value nets. In an embodiment of the invention, a value net analysis method can include loading data for CBM components of a first value net for a first collection of business enterprises, and loading data for CBM components of a second value net for a second collection of business enterprises. The method also can include mapping relationships between different business enterprises in the first value net to relationships between different business enterprises in the second value net. Relative underperformance can be identified in a mapped relationship in one of the value nets based upon a comparison of the loaded data for the CBM components of the value nets. Consequently, the under-performing mapped relationship can be visually distinguished in an enterprise view to a corresponding one of the value nets.

### BACKGROUND OF THE INVENTION

1. Field of the Invention

The present invention relates to the field of component business modeling of a business enterprise and more particularly to value network monitoring and analysis.

2. Description of the Related Art

Component business modeling (CBM) is a technique for modeling a business and its corresponding business activities based on “business components”. Each business component includes a relatively independent collection of business activities. CBM provides a simple business view for strategic-level business analysis of a single business enterprise and differs from traditional business process-based models such as value chains, which provide a transactional view of the business. Notably, CBM facilitates qualitative analysis techniques, such as dependency analysis to identify one or more components associated with a business pain point, heat map analysis also to identify one or more components associated with a business pain point, and overlay analysis to identify a shortfall of the identified component or components. A general overview of CBM can be found in United States Patent Application Publication No. US 2007/0118551 by Rama K. T. Akkiraju et al.

A semantic business model is a representation of a CBM assisting in the automation of the qualitative analyses facilitated by CBM. The semantic business model generally includes a representation of the CBM in a semantic markup language, such as the resource description framework (RDF) or the web ontology language (OWL). The semantic business model captures relationships between various business concepts, such as one or more business components, business processes, business activities, operational metrics, performance indicators, value drivers, applications, computing capabilities, and resources, including human resources. As a result, the semantic business model can be used to discover implicit facts in the analyses using the inference capabilities of an ontology.

The application of CBM to the single enterprise system has proven quite effective, however, over the last decade, business models have evolved into complex multi-enterprise collaborations, causing new kinds of in-efficiencies in processes for product and service development and delivery. In particular, in some industries, hundreds of suppliers and thousands of dealers form a value chain for delivering complex products and services to end customers. In order to support efficient operations, business processes are stretched and extended in ad-hoc fashions across into the supply-chains for ensuring traceable chains and improved accountability. Though these processes in the short-term are efficient, in the long-term these processes have an impact on the performance of the value chain because of complex inter-relationships.

As noted, CBM can represent a business and its functions as autonomous components and, in that circumstance, has proven effective in facilitating better decision-making across many different industrial sectors. However, the modeling capability of CBM only has been defined for a single enterprise. CBM cannot capture information about multiple enterprises in the scenario of a “business value model”. Generally, a business value model glues together business entities and inter-relationships of value generating single enterprise entities into a network of interacting and value generating enterprise entities. These entities frequently are denoted in the literature as collaboration, value nets, or value networks. Notably, while scholars such as David Bovet and Joseph Martha have proposed modeling value networks at least in the supply chain context and while work has been performed in using semantic analysis for information integration, an integrated view of a value net of disparately modeled enterprise entities remains elusive.

As compared to value chains, value networks represent a novel approach to model complex enterprise relationships from the perspective of value creation, propagation, and evolution. The success of a value network relies on timely sensing of business insights from high volume process and product performance information. Recently, it has been proposed facilitate modeling and analysis of a value network of multiple different enterprises through the unification of business knowledge of the multiple enterprises and their diverse and conflicting objectives in the value network, the sensing of the value network and processes through a real-time system, and the analysis of the quantifiable value each enterprise contributes to the value network.

### BRIEF SUMMARY OF THE INVENTION

Embodiments of the present invention address deficiencies of the art in respect to modeling value networks and provide a novel and non-obvious method, system and computer program product for a comparative analysis different value nets. In an embodiment of the invention, a value net analysis method can include loading data for CBM components of a first value net for a first collection of business enterprises, and loading data for CBM components of a second value net for a second collection of business enterprises. The method also can include mapping relationships between different business enterprises in the first value net to relationships between different business enterprises in the second value net. Relative underperformance can be identified in a mapped relationship in one of the value nets based upon a comparison of the loaded data for the CBM components of the value nets. Consequently, the under-performing mapped relationship can be visually distinguished in an enterprise view to a corresponding one of the value nets.

Identifying relative under-performance in a mapped relationship in one of the value nets can include defining key performance indicators for CBM components of the first value net. Further, the defined key performance indicators can be applied to the CBM components of the second value net and the key performance indicators can be compared for the value nets. Finally, key performance indicators demonstrating under-performance can be detecting. Likewise, relative over-performance can be identified in a mapped relationship in one of the value nets based upon a comparison of the loaded data for the CBM components of the value nets, and the over-performing mapped relationship can be visually distinguished in an enterprise view to a corresponding one of the value nets.

In another embodiment of the invention, a data processing system can be configured for modeling, visualization and analysis of value nets. The system can include a distributing monitoring system of different CBM components in different servers for different business enterprises arranged in different value nets. The system also can include a host computing platform including a semantic engine coupled to a repository of metrics collected from the distributed monitoring system. Finally, a workbench can be provided to generate different enterprise views of the different CBM components for selected ones of the value nets. In this regard, at least one of the enterprise views can include a visually emphasized CBM component in one of the value nets demonstrating under-performance relative to a semantically equivalent CBM component for another one of the value nets. Optionally, at least one other of the enterprise views can include a visually emphasized CBM component in one of the value nets demonstrating over-performance relative to a semantically equivalent CBM component for another one of the value nets.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a method, system and computer program product for value network performance comparison;

FIG. 2 is a block diagram illustrating a semantic business model configured for application to the value network of FIG. 1;

FIG. 3 is a schematic illustration of a data processing system configured for value network performance comparison; and,

FIG. 4 is a flow chart illustrating a process for value network performance comparison.

### DETAILED DESCRIPTION OF THE INVENTION

Embodiments of the present invention provide a method, system and computer program product for value network performance person through the modeling, visualization and analyzing different value networks. In accordance with an embodiment of the present invention, two different value networks can be modeled on a CBM by CBM basis. Each CBM can be organized hierarchically according to key performance indicators and metrics can be collected for each of the key performance indicators. Correlations can be drawn between different CBMs to infer causal relationships for the metrics of the pain points. Thereafter, selected ones of the CBMs in each of the value networks can be mapped to one another according to like function. As such, the metrics for the key performance indicators can be compared between the selected ones of the CBMs and under-performing or over-performing ones of the key performance indicators can be visually expressed in a dashboard view of the comparison of the value networks.

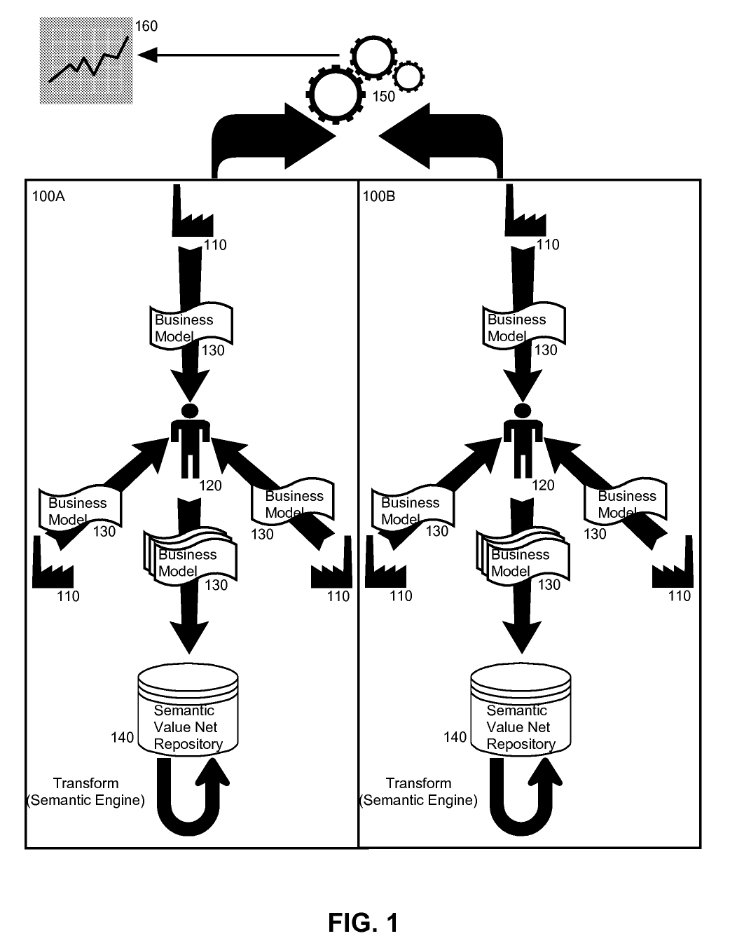

In illustration, FIG. 1 pictorially shows a method, system and computer program product for comparing value networks through a modeling, visualization and analysis of the value networks. As shown in FIG. 1, different value nets 100A, 100B can be modeled for respectively different value networks. Each of the value nets 100A, 100B can include a collection of CBMs 130 each modeling a specific business enterprise 110 arranged with respect to a central business enterprise 120. Each CBM 130 can represent the business functions of entire enterprise 110 in a simple tabular framework as described in Mao Chen, Anca-Andreea Ivan and Jakka Sairamesh, Deep Visibility in Enterprise Value Networks: Knowledge Models, Real-Time Monitoring and E-Commerce, in PROCEEDINGS OF THE 8TH IEEE INTERNATIONAL CONFERENCE ON E-COMMERCE TECHNOLOGY AND THE 3RD INTERNATIONAL CONFERENCE ON ENTERPRISE COMPUTING (March 2006), hereinafter “Deep Visibility”, the contents and teachings of which are incorporated herein by reference. As described in Deep Visibility, businesses are divided by their functionality in the columns of the tabular framework, which are further broken down into business components according to the three layers in a company: executive, managerial, and execution.

Semantic value net repository 140 can be provided for each value net 100A, 100B. The semantic value net repository 140 can include a data store of semantics for each CBM 130 such that disparate semantics used in each CBM 130 can be transformed into common semantics to one another for the purpose of harmonizing metrics collected for each CBM 130. As such, the collected metrics can be correlated and visualized for the entire value net 100A, 100B as described in Deep Visibility. In this regard, different metrics from the different CBMs 130 can be correlated to one another in order to visually identify causal relationships in the performance of each CBM 130, and further in order to identify to inconsistencies in the performance of each CBM 130 in order to achieve the performance objectives of the central business enterprise 120.

Notably, a value net comparison engine 150 can be coupled to each of the value nets 100A, 100B. The value net comparison engine 150 can access each semantic value net repository 140 in order to further compare the performance of different CBMs 130 in the different value nets 100A, 100B. In this way, the performance and interaction between related ones of the CBMs 130 in the different value nets 100A, 100B can be compared to one another to identify under-performing or over-performing CBMs 130 in a selected one of the value nets 100A, 100B. Additionally, the under-performance or over-performance of one or more of the CBMs 130 for a selected one of the value nets 100A, 100B can be rendered visually in a dashboard view 160 of the selected one of the value nets 100A, 100B representative of the tabular view of the selected one of the value nets 100A, 100B.

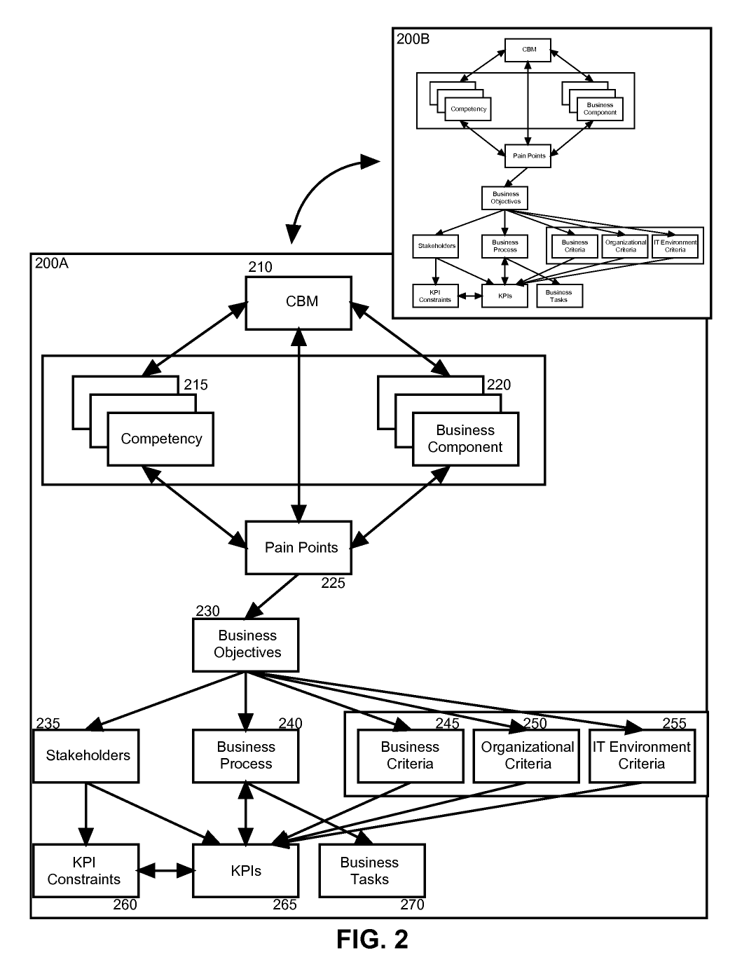

In further illustration, FIG. 2 shows a block diagram illustrating a comparison of different semantic business models in different value nets, each being configured for application to a value net 100A, 100B of FIG. 1. As shown in FIG. 2, a value net 200A can include a model of a CBM 210 that include different business components 220 executing in a computing host and configured to manage the performance of a business competency 215 of a corresponding business enterprise. Different pain points 225 can be determined for each of the business components 220 and corresponding competencies 215. Each of the pain points 225 can reference a business objective 230 related to a corresponding business component 220. The business objective 230 can rely upon defined relationships to one or more stake holders 235, one or more business processes 240 including one or more business tasks 270, and any combination of business criteria 245, organizational criteria 250 and information technology (IT) criteria 255 as described in Deep Visibility.

Of importance, key performance indicators 265 can be established for the business process 240 and can reference related stakeholders 235. The key performance indicators 265 as described in Deep Visibility define portions of the business process 240 for which performance can be determinative of the overall performance of the business process 240 and in turn of the overall performance of the business enterprise incorporating the CBM 210. On an individual basis, the key performance indicators 265 can be constrained by key performance indicator constraints 260 and when compared to industrial benchmarks, can indicate the general performance of an associated business process 240. Further, when comparing the key performance indicators 265 of like business processes between the CBM 210 of one value net 200A and a related CBM 210 of another value net 200B, a relative performance can be determined.

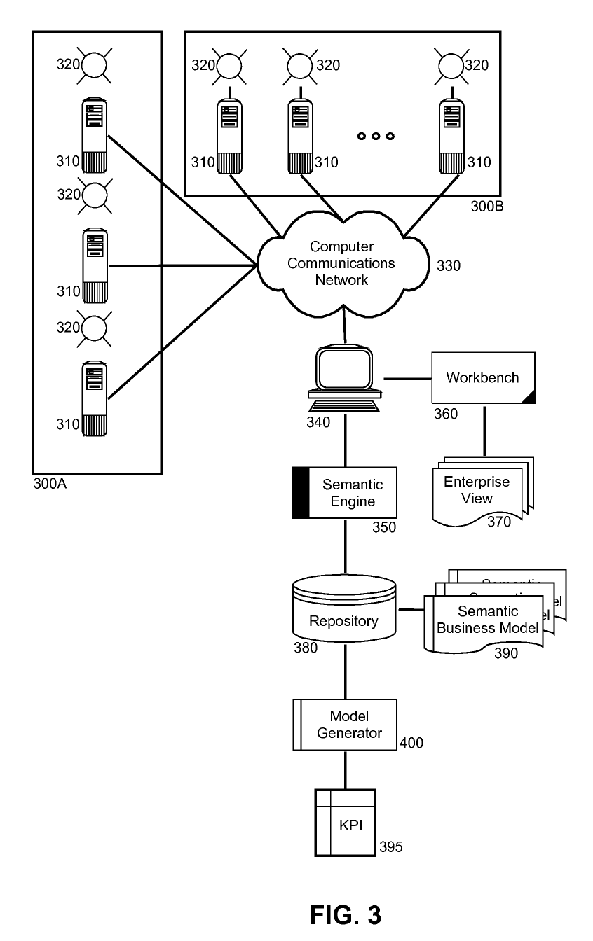

The comparison of value nets 200A, 200B can be performed within a value net data processing system configured for modeling, visualization and analysis of value nets. In yet further illustration, FIG. 3 is a schematic illustration of a data processing system configured for modeling, visualization and analysis of value nets. The system can include a host computing platform 340 configured for coupling to different value networks 300A, 300B over a computer communications network 330 such as the global Internet. Each of the different value networks 300A, 300B can include different host servers 310 for different respective business enterprises, each supporting the execution of a distributed monitoring system 320. The components of the distributed monitoring system 320 continuously monitor and measure the performance of each business enterprise.

The host computing platform 340 can include a workbench 360 and a semantic engine 350. The semantic engine 350 can be coupled to a repository of metrics 380 collected from the distributed monitoring system 320 and organized according different semantic business models 390 produced by coupled model generator 395. The model generator 395 further can be coupled to table of key performance indicators 385 associating key performance indicators with different components in the different business enterprises of the different value networks 300A, 300B. Workbench 360 can provide a user interface to different business enterprise views 370, each of the enterprise views 370 providing a view to the different components of a corresponding business enterprise in a selected one of the value networks 300A, 300B.

Each of the enterprise views 370 further can provide an indication of the performance of the components according to metrics collected from the distributed monitoring system 320 and the key performance indicators in the table 385. Of note, the enterprise views 370 can include a view of under-performing and over-performing components of a component in a selected one of the value networks 300A, 300B through a comparison of the performance of a corresponding component in another component in another one of the value networks 300A, 300B.

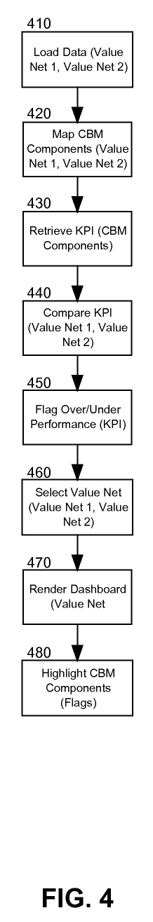

In even yet further illustration of the process of comparing the performance of different value networks, FIG. 4 is a flow chart illustrating a process for value network performance comparison. Beginning in block 410, performance metrics for the CBM components of two value networks can be loaded for analysis. In block 420, the CBM components of each of the value networks can be mapped to one another according to semantic equivalence. In block 430, the key performance indicators for the CBM components can be retrieved and in block 440, the key performance indicators can be compared to one another to determine the relative performance of mapped ones of the CBM components.

In block 450, relatively under-performing and over-performing key performance indicators can be flagged. Thereafter, a particular one of the value networks can be selected for analysis. In block 470, an enterprise view of the particular one of the value networks can be rendered to show the different CBM components of the particular one of the value networks. Further, in block 480, the relatively under-performing and over-performing ones of the CBM components associated with the flagged key performance indicators can be visually distinguished as under-performing or over-performing, as the case may be. For example, under-performing components can be highlighted in red while over-performing components can be highlighted in green.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A value net analysis method comprising:
loading data for component business model (CBM) components of a first value net for a first collection of business enterprises;
loading data for CBM components of a second value net for a second collection of business enterprises;
mapping relationships between different business enterprises in the first value net to relationships between different business enterprises in the second value net;
identifying relative underperformance in a mapped relationship in one of the value nets based upon a comparison of the loaded data for the CBM components of the value nets; and,
visually distinguishing the underperforming mapped relationship in an enterprise view to a corresponding one of the value nets.

2. The method of claim 1, wherein identifying relative under-performance in a mapped relationship in one of the value nets, comprises:
defining key performance indicators for CBM components of the first value net;
applying the defined key performance indicators to the CBM components of the second value net;
comparing the key performance indicators of the value nets; and,
detecting key performance indicators demonstrating under-performance.

3. The method of claim 1, further comprising:
identifying relative over-performance in a mapped relationship in one of the value nets based upon a comparison of the loaded data for the CBM components of the value nets; and,
visually distinguishing the over-performing mapped relationship in an enterprise view to a corresponding one of the value nets.

4. The method of claim 3, wherein identifying relative over-performance in a mapped relationship in one of the value nets, comprises:
defining key performance indicators for CBM components of the first value net;
applying the defined key performance indicators to the CBM components of the second value net;
comparing the key performance indicators of the value nets; and,
detecting key performance indicators demonstrating over-performance.

5. A data processing system configured for modeling, visualization and analysis of value nets, the system comprising:
a distributing monitoring system of different component based modeling (CBM) components in different servers for different business enterprises arranged in different value nets;
a host computing platform comprising a semantic engine coupled to a repository of metrics collected from the distributed monitoring system; and,
a workbench generating different enterprise views of the different CBM components for selected ones of the value nets, at least one of the enterprise views comprising a visually emphasized CBM component in one of the value nets demonstrating under-performance relative to a semantically equivalent CBM component for another one of the value nets.

6. The system of claim 5, wherein at least one other of the enterprise views comprises a visually emphasized CBM component in one of the value nets demonstrating over-performance relative to a semantically equivalent CBM component for another one of the value nets.

7. A computer program product comprising a computer usable medium embodying computer usable program code for value net analysis, the computer program product comprising:
computer usable program code for loading data for component business model (CBM) components of a first value net for a first collection of business enterprises;
computer usable program code for loading data for CBM components of a second value net for a second collection of business enterprises;
computer usable program code for mapping relationships between different business enterprises in the first value net to relationships between different business enterprises in the second value net;
computer usable program code for identifying relative underperformance in a mapped relationship in one of the value nets based upon a comparison of the loaded data for the CBM components of the value nets; and,
computer usable program code for visually distinguishing the underperforming mapped relationship in an enterprise view to a corresponding one of the value nets.

8. The computer program product of claim 7, wherein the computer usable program code for identifying relative under-performance in a mapped relationship in one of the value nets, comprises:
computer usable program code for defining key performance indicators for CBM components of the first value net;
computer usable program code for applying the defined key performance indicators to the CBM components of the second value net;
computer usable program code for comparing the key performance indicators of the value nets; and,
computer usable program code for detecting key performance indicators demonstrating under-performance.

9. The computer program product of claim 7, further comprising:
computer usable program code for identifying relative over-performance in a mapped relationship in one of the value nets based upon a comparison of the loaded data for the CBM components of the value nets; and,
computer usable program code for visually distinguishing the over-performing mapped relationship in an enterprise view to a corresponding one of the value nets.

10. The computer program product of claim 9, wherein the computer usable program code for identifying relative over-performance in a mapped relationship in one of the value nets, comprises:
computer usable program code for defining key performance indicators for CBM components of the first value net;
computer usable program code for applying the defined key performance indicators to the CBM components of the second value net;
computer usable program code for comparing the key performance indicators of the value nets; and,
computer usable program code for detecting key performance indicators demonstrating over-performance.
